(19) United States
(12) Patent Application Publication
(10) Pub. No.: US 2026/0179244 A1
(43) Pub. Date: Jun. 25, 2026

(54) SYSTEM FOR VEHICLE OCCUPANT POSTURE MONITORING

(71) Applicant: Harman Becker Automotive Systems GmbH, Karlsbad (DE)

(72) Inventors: Marcus FUTTERLIEB, Karlsbad (DE); Chirudeep Reddy BHIMAVARAPU, Karlsbad (DE)

(21) Appl. No.: 19/362,107

(22) Filed: Oct. 17, 2025

(30) Foreign Application Priority Data
Dec. 20, 2024 (DE) 202024107475.0
Jun. 12, 2025 (DE) 202025103286.4

(51) Int. Cl. G06T 7/70; B60N 2/00; B60N 2/90; B60Q 9/00; G06F 3/01; G06T 7/00

(52) U.S. Cl. CPC G06T 7/70; B60N 2/0021; B60N 2/90; B60Q 9/00; G06T 7/0002; B60N 2002/981; G06F 3/016; G06T 2207/30196; G06T 2207/30268

(57) ABSTRACT

Systems are herein provided for occupant posture monitoring. In one example, a system for a vehicle comprises a camera, and a computing system including instructions stored in non-transitory memory that, when executed, cause the computing system to receive images captured of an occupant in the vehicle from the camera, determine body measurements of the occupant from the received images, determine a current posture of the occupant from the received images, determine a recommended posture for the occupant based on the determined body measurements, and output a first command responsive to a difference between the current posture and the recommended posture exceeding a threshold difference, wherein the first command is configured to cause one or more actuators to provide force feedback to the occupant.

### CROSS REFERENCE TO RELATED APPLICATIONS

The present application claims priority to German Utility Model Application No. 20 2024 107 475.0, entitled “SYSTEM FOR VEHICLE OCCUPANT POSTURE MONITORING”, and filed on Dec. 20, 2024. The present application also claims priority to German Utility Model Application No. 20 2025 103 286.4, entitled “SYSTEM FOR VEHICLE OCCUPANT POSTURE MONITORING”, and filed on Jun. 12, 2025. The entire contents of each of the above-listed applications are hereby incorporated by reference for all purposes.

### TECHNICAL FIELD

The present disclosure relates to a camera-based vehicle occupant posture monitoring system.

### BACKGROUND

Driving posture may affect the health and comfort of an operator of a vehicle. However, it may be difficult for the operator to monitor their own posture while focusing on vehicle operation. As another example, different vehicle occupants, including different operators during different vehicle trips, may have different sizes, including height, weight, and proportions. Therefore, seat settings for one occupant may not facilitate optimal posture for another occupant, and it may be difficult for the occupant to find comfortable and ergonomic seat settings through manual adjustment (e.g., controlled by the occupant). Furthermore, even if a seat position can be considered optimal for an occupant, especially during long vehicle trips, occupants may take on a bad body posture nevertheless.

### SUMMARY

In various embodiments, the issues described above may be addressed by a system for a vehicle, the system including a camera, and a computing system including instructions stored in non-transitory memory that, when executed, cause the computing system to receive images captured of an occupant in the vehicle from the camera, determine body measurements of the occupant from the received images, determine a current posture of the occupant from the received images, determine a recommended posture for the occupant based on the determined body measurements, and output a first command responsive to a difference between the current posture and the recommended posture exceeding a threshold difference, wherein the first command is configured to cause one or more actuators to provide force feedback to the occupant.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1 systematically shows a vehicle system, according to one or more embodiments of the present disclosure;

FIG. 2 shows a block diagram of a flow of data during occupant posture detection, according to one or more embodiments of the present disclosure; and

FIG. 3 shows a flow chart of a method for determining occupant posture.

FIG. 4 shows an example of a recommended driving posture, according to one or more embodiments of the present disclosure;

FIG. 5 shows a first example of an incorrect driving posture, according to one or more embodiments of the present disclosure;

FIG. 6 shows a block diagram of a vehicle system, according to one or more embodiments of the present disclosure.

FIG. 7 shows a flow chart of a method for increasing vehicle occupant comfort by means of a vehicle system, according to one or more embodiments of the present disclosure.

### DETAILED DESCRIPTION

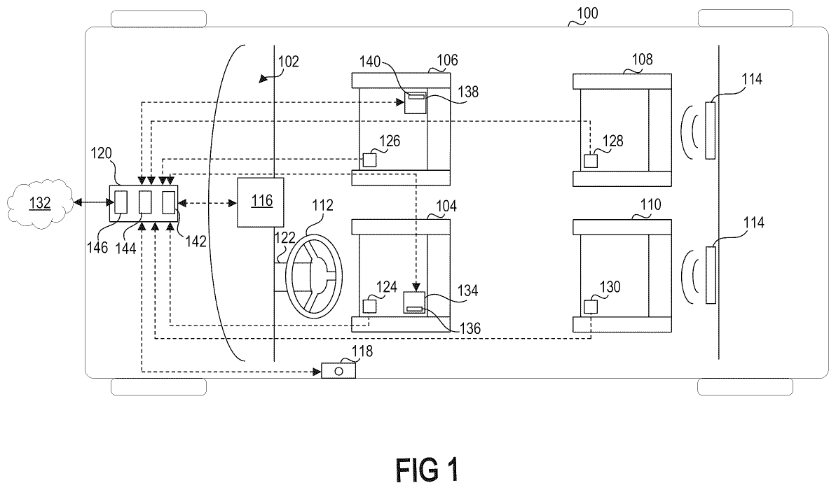

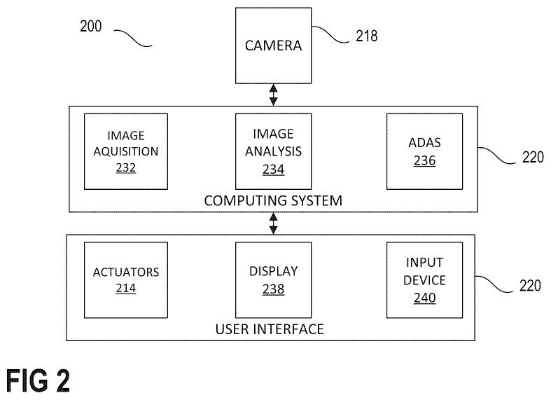

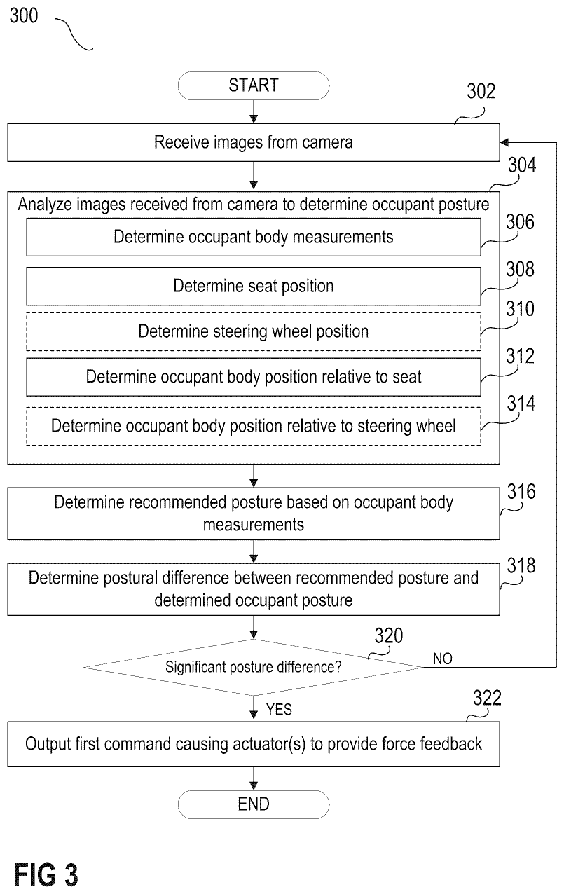

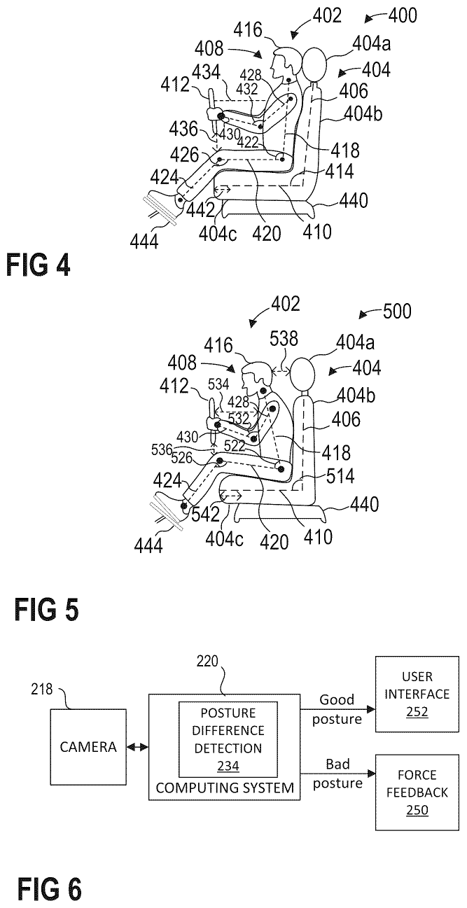

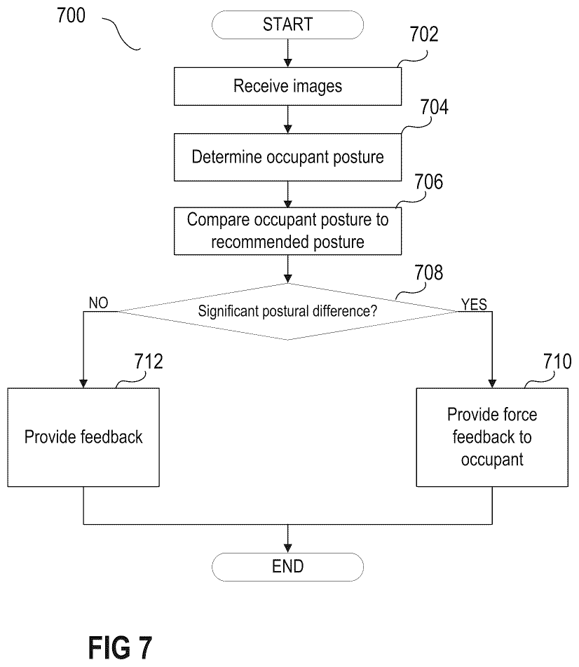

The following description relates to systems and methods to increase vehicle occupant comfort via an occupant monitoring system. The occupant monitoring system may include a camera mounted in a vehicle, such as the vehicle shown in FIG. 1. A computing system may process and analyze images received from the camera to determine a posture of the occupant, such as a driver (e.g., operator) or a passenger of the vehicle, and guide posture corrections, such as according to the data flow block diagram shown in FIG. 2. As an example, the computing system may receive images acquired by the camera as well as body measurement data of the occupant. The computing system may use image and data processing resources included in an in-vehicle processing system, a mobile processing system, or a networked processing system (e.g., cloud computing) to identify suitable posture choices, determine whether a current posture significantly differs from the suitable posture choices, and encourage the occupant to change their posture, such as according to the method of FIG. 3. FIGS. 4 and 5 show various measurements and relationships between the occupant, a seat, and a steering wheel that the computing system may analyze in determining the posture of the occupant. In particular, an exemplary recommended posture is shown in FIG. 4, while FIG. 5 provides an example of an incorrect driver posture that may lead to driver discomfort or fatigue. A block diagram of a vehicle system, according to one or more embodiments of the present disclosure, is shown in FIG. 6. A flow chart of a method for increasing vehicle occupant comfort by means of a vehicle system is shown in FIG. 7, which may use the images and body measurement data analyzed in the method of FIG. 3. In this way, driver and passenger comfort may be increased from vehicle entry to vehicle exit and with minimal or no input from the occupants.

Turning now to the figures, FIG. 1 schematically shows an exemplary vehicle 100. The vehicle 100 includes a dashboard 102, a driver seat 104, a first passenger seat 106, a second passenger seat 108, and a third passenger seat 110. In other examples, the vehicle 100 may include more or fewer passenger seats. The driver seat 104 and the first passenger seat 106 are located in a front of the vehicle, proximate to the dashboard 102, and therefore may be referred to as front seats. The second passenger seat 108 and the third passenger seat 110 are located at a rear of the vehicle and may be referred to as back (or rear) seats.

The vehicle 100 further includes a steering wheel 112 and a steering column 122, through which the driver may input steering commands for the vehicle 100. The steering column 122 may be adjustable so that the driver may change a height and/or tilt of the steering wheel 112 by adjusting the steering column 122. In some examples, the steering column 122 may be adjusted by the driver disengaging a lever or lock on the steering column 122 and manually moving the steering column 122 and/or steering wheel 112 to adjust the height and/or tilt of the steering wheel 112. In other examples, the position of the steering column 122 and the steering wheel 112 may be adjusted via an electric motor integrated within the steering column 122. The driver may input adjustments to the electric motor, such as via an interface (e.g., a button or switch) positioned on the steering column 122, or the computing system 120 may actuate the electric motor to adjust the position of the steering column 122 and the steering wheel 112 based on a stored setting for the driver.

The vehicle 100 further includes a camera 118. The camera 118 may be included in a driver monitoring system (e.g., a driver attention monitor). In the embodiment shown in FIG. 1, the camera 118 is positioned to the side of the driver seat 104, which may aid in monitoring the driver in profile. However, in other examples, the camera 118 may be positioned in other locations in the vehicle 100, such as on the steering column 122 and directly in front of the driver seat 104. The camera 118 may include one or more optical (e.g., visible light) cameras, one or more infrared (IR) cameras, or a combination of optical and IR cameras having one or more view angles. In some examples, the camera 118 may have interior view angles as well as exterior view angles. In some examples, the camera 118 may include more than one lens and more than one image sensor. For example, the camera 118 may include a first lens that directs light to a first, visible light image sensor (e.g., a charge-coupled device or a metal-oxide-semiconductor) and a second lens that directs light to a second, thermal imaging sensor (e.g., a focal plane array), enabling the camera 118 to collect light of different wavelength ranges for producing both visible and thermal images. In some examples, the camera 118 may further include a depth camera and/or sensor, such as a time-of-flight camera or a LiDAR sensor. In some examples, the camera 118 may be configured to capture suitable images even under low light conditions without the need for visible illumination. That is, for example, the camera 118 may be able to capture suitable images even during night drives without the need for visible illumination (e.g., flash), as visible illumination in such situations may startle and distract the occupant(s) of the vehicle 100 which may lead to hazardous situations and accidents.

In some examples, the camera 118 may be a digital camera configured to acquire a series of images (e.g., frames) at a programmable frequency (e.g., frame rate) and may be electronically and/or communicatively coupled to the computing system 120. Further, the camera 118 may output acquired images to the computing system 120 in real-time so that they may be processed in real-time by the computing system 120 and/or a computer network, as will be elaborated herein with particular respect to FIGS. 2 and 6. As used herein, the term “real-time” denotes a process that occurs instantaneously and without intentional delay. “Real-time” may refer to a response time of less than or equal to about 1 second, for example. In some examples, “real-time” may refer to simultaneous or substantially simultaneous processing, detection, or identification. Further, in some examples, the camera 118 may be calibrated with respect to a world coordinate system (e.g., world space x, y, z).

The vehicle 100 may further include a driver seat sensor 124 coupled to or within the driver seat 104 and a passenger seat sensor 126 coupled to or within the first passenger seat 106. The back seats may also include seat sensors, such as a passenger seat sensor 128 coupled to the second passenger seat 108 and a passenger seat sensor 130 coupled to the third passenger seat 110. The driver seat sensor 124 and the passenger seat sensor 126 may each include one or a plurality of sensors, such as a weight sensor, a pressure sensor, and one or more seat position sensors that output a measurement signal to the computing system 120. For example, the output of the weight sensor or pressure sensor may be used by the computing system 120 to determine whether or not the respective seat is occupied, and if occupied, a weight of a person occupying the seat. As another example, the output of the one or more seat position sensors may be used by the computing system 120 to determine one or more of a seat height, a longitudinal position with respect to the dashboard 102 and the back seats, and an angle (e.g., tilt) of a seat back of the corresponding seat. In other examples, the seat position may be additionally or alternatively determined based on images acquired by the camera 118, such as will be elaborated herein. According to some examples, it is alternatively or additionally possible that the weight of an occupant be determined based on images acquired by the camera 118.

In some examples, the vehicle 100 further includes a driver seat motor 134 coupled to or positioned within the driver seat 104 and a passenger seat motor 138 coupled to or positioned within the first passenger seat 106. Although not shown, in some embodiments, the back seats may also include seat motors. The driver seat motor 134 may be used to adjust the seat position, including the seat height, the longitudinal seat position, and the angle of the seat back of the driver seat 104 and may include an adjustment input 136. For example, the adjustment input 136 may include one or more toggles, buttons, and switches. The driver may input desired driver seat position adjustments to the driver seat motor 134 via the adjustment input 136, and the driver seat motor 134 may move the driver seat 104 accordingly in substantially real-time. In other examples, the driver seat motor 134 may adjust the driver seat position based on inputs received from the computing system 120. The passenger seat motor 138 may adjust a seat position of the passenger seat 106 based on inputs received from an adjustment input 140 and/or based on inputs received from the computing system 120 in an analogous manner. Further, in some examples, the computing system 120 may determine the seat position of the corresponding seat based on feedback from the driver seat motor 134 and the passenger seat motor 138. Although not shown, in some embodiments, the back seats may be adjustable in a similar manner.

In some examples, the vehicle 100 further includes an in-cabin radar unit (not specifically illustrated. The in-cabin radar unit may be a 60 GHz radar unit, for example. The in-cabin radar unit may be included in the driver monitoring system (e.g., a driver attention monitor). The in-cabin radar unit may be positioned to the side of the driver seat 104, for example, which may aid in monitoring the driver in profile. However, in other examples, the in-cabin radar unit may be positioned in other locations in the vehicle 100, such as on the steering column 122 and directly in front of the driver seat 104. For example, the output of the in-cabin radar unit may be used by the computing system 120 to determine whether or not the respective seat is occupied. Some high-resolution in-cabin radar units may even allow the computing system 120 to determine an occupant posture based on the output received from the in-cabin radar unit.

The computing system 120 may receive inputs via the user interface 116 as well as output information to the user interface 116. The user interface 116 may be included in a digital cockpit or advanced driver assistance system (ADAS), for example, and may include a display and one or more input devices. The one or more input devices may include one or more touchscreens, knobs, dials, hard buttons, and soft buttons for receiving user input from a vehicle occupant.

The computing system 120 includes a processor 142 configured to execute machine readable instructions stored in a memory 144. The processor 142 may be single core or multi-core, and the programs executed by processor 142 may be configured for parallel or distributed processing. In some embodiments, the processor 142 is a microcontroller. The processor 142 may optionally include individual components that are distributed throughout two or more devices, which may be remotely located and/or configured for coordinated processing. In some embodiments, one or more aspects of the processor 142 may be virtualized and executed by remotely-accessible networked computing devices configured in a cloud computing configuration. For example, the computing system 120 may be communicatively coupled with a wireless network 132 via a transceiver 146, and the computing system 120 may communicate with the networked computing devices via the wireless network 132. Additionally or alternatively, the computing system 120 may directly communicate with the networked computing devices via short-range communication protocols, such as Bluetooth®. In some embodiments, the computing system 120 may include other electronic components capable of carrying out processing functions, such as a digital signal processor, a field-programmable gate array (FPGA), or a graphic board. In some embodiments, the processor 142 may include multiple electronic components capable of carrying out processing functions. For example, the processor 142 may include two or more electronic components selected from a plurality of possible electronic components, including a central processor, a digital signal processor, a field-programmable gate array, and a graphics board. In still further embodiments, the processor 142 may be configured as a graphical processing unit (GPU), including parallel computing architecture and parallel processing capabilities.

Further, the memory 144 may include any non-transitory tangible computer readable medium in which programming instructions are stored. As used herein, the term “tangible computer readable medium” is expressly defined to include any type of computer readable storage. The example methods described herein may be implemented using coded instruction (e.g., computer readable instructions) stored on a non-transitory computer readable medium such as a flash memory, a read-only memory (ROM), a random-access memory (RAM), a cache, or any other storage media in which information is stored for any duration (e.g. for extended period time periods, permanently, brief instances, for temporarily buffering, and/or for caching of the information). Computer memory of computer readable storage mediums as referenced herein may include volatile and non-volatile or removable and non-removable media for a storage of electronically formatted information, such as computer readable program instructions or modules of computer readable program instructions, data, etc. that may be stand-alone or as part of a computing device. Examples of computer memory may include any other medium which can be used to store the desired electronic format of information and which can be accessed by the processor or processors or at least a portion of a computing device. In various embodiments, the memory 144 may include an SD memory card, an internal and/or external hard disk, USB memory device, or a similar modular memory.

Further still, in some examples, the computing system 120 may include a plurality of sub-systems or modules tasks with performing specific functions related to performing image acquisition and analysis. As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

“Systems,” “units,” or “modules” may include or represent hardware and associated instructions (e.g., software stored on a tangible and non-transitory computer readable storage medium) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations. For example, as will be elaborated herein with respect to FIG. 3, the computing system 120 may determine an occupant posture based on the images received from the camera 118, determine a desired (e.g., recommended) occupant posture based on body measurements, determine a difference between the occupant posture and the desired occupant posture, and output a first command responsive to a difference between the current posture and the recommended posture exceeding a threshold difference, wherein the first command is configured to cause one or more actuators to provide force feedback to the occupant.

A data flow between various devices in performing the occupant posture determination will now be described. Turning to FIG. 2, a block diagram of an example data flow 200 is shown. A camera 218 provides image data to a computing system 220. The camera 218 may be similar to, or the same as, the camera 118 of FIG. 1, and the computing system 220 may be similar to, or the same as, the computing system 120 of FIG. 1. The computing system 220 includes an image acquisition module 232, an image analysis module 234, and (optionally) an advanced driver assistance system, ADAS, module 236. The image acquisition module 232 may send and receive data to and from the camera 218. For example, the image acquisition module 232 may control acquisition settings of the camera 218, such as aperture, light sensitivity, focal depth, field of view, shutter speed, frame rate, etc. In some examples, the camera 218 may operate at a frame rate in a range between 4-24 frames per second to substantially continuously capture images of a vehicle interior. In other examples, the frame rate may be lower, such as one frame per second or per multiple seconds (e.g., 30-60 seconds), or higher (e.g., 30 frames per second). As one example, the frame rate may be selected based on a processing speed of the image analysis module 234 so that each image may be fully analyzed before the image analysis module 234 receives a next image in the sequence.

Further, the image acquisition module 232 may update the acquisition settings of the camera 218 based on feedback received from the image analysis module 234. For example, the image analysis module 234 may determine that the images acquired by the camera 218 are too dark and update one or more of the aperture, the light sensitivity, and the shutter speed at the image acquisition module 232 accordingly.

The image analysis module 234 may access images/videos (e.g., an image library) stored in memory and analyze the images received from the camera 218 in real-time to identify one or more features within each of the received image. As one example, the image analysis module 234 may compare a real-time image received from the camera 218 to one stored in memory to identify occupants within the vehicle interior, including a driver and/or a non-driver occupant (e.g., passenger). Additionally or alternatively, the image analysis module 234 may use a computer vision model or algorithm to identify the driver and/or non-driver occupant. In some examples, the image analysis module 234 may further analyze the image, such as using a biometric algorithm that performs facial recognition, to positively identify the occupant(s). As an illustrative example, the biometric algorithm may compare a face of the driver to identification photos of all known drivers of the vehicle to positively identify the driver. Further, the computing system 220 may store user-specific settings and information, including ingress and egress seat settings associated with each known/repeated vehicle occupant, in memory.

In some examples, the image analysis module 234 may construct a model of each occupant that includes skeletal tracking. The skeletal tracking may identify various skeletal joints of the occupant (e.g., the driver or the passenger), which may correspond to actual joints of the occupant, centroids of various anatomical structures, terminal ends of the occupant's extremities, and/or points without a direct anatomical link within the occupant (e.g., not corresponding to a particular anatomical structure), and map a simplified virtual skeleton onto the occupant. As each joint of the occupant has at least three degrees of freedom (e.g., world space x, y, z), each joint of the virtual skeleton used for the skeletal tracking may be defined with a three-dimensional (3D) position, and changes in that 3D position may denote movement. In some examples, each joint of the virtual skeleton may also be defined with respect to rotational angle within the 3D world space and with respect to a centerline of the virtual skeleton. In some examples, the image analysis module 234 may use depth and/or visible light information acquired by the camera 218 to define an envelope of the occupant (e.g., the surface area and volume of the occupant), which in turn may be used to approximate a size of the occupant (e.g., a body mass index, height, etc.). As will be elaborated herein and illustrated with respect to FIGS. 4 and 5, the virtual skeleton may be used to determine limb lengths and joint angles. The limb lengths and joint angles may be used by the image analysis module 234, alone or in combination with the envelope, to determine a 3D posture estimation as well as a recommended (e.g., desired) posture for the particular occupant that will increase comfort and/or health given the size and limb lengths of the individual. Additional details will be described below with respect to FIG. 3.

In some examples, the computing system 220 may receive body measurement inputs from the occupant(s) in addition to or as an alternative to determining the envelope. For example, the ADAS module 236 may prompt the occupant to input height and weight measurements via a user interface 216, which may be similar to, or the same as, the user interface 116 shown in FIG. 1. In particular, the height and weight measurements may be received via an input device 240, and the ADAS module 236 may share the received information with the image analysis module 234. In some examples, the user interface 216 may be included in a smartphone (or tablet, smartwatch, etc.), and the smartphone may run a companion application (often also referred to as companion app) that interfaces with the ADAS module 236 of the in-vehicle computing system 220 to receive inputs from the occupant.

In some examples, the computing system 220 may additionally or alternatively receive occupant weight measurements from seat sensors. For example, a driver seat sensor (e.g., the driver seat sensor 124) may output a driver weight measurement to the computing system 220, and the weight measurement may be used by the image analysis module 234, alone or in combination with the images from the camera 218 and/or the measurements received via the input device 240, to determine body measurements of the driver.

Further, it may be understood that in some examples, the image analysis module 234 may be included in the in-vehicle computing system 220 or accessed via a user-provided mobile computing system, such as a smartphone, computer, or tablet. As another example, the image analysis module 234 may be included via a networked computing system such as a cloud computer or a similar computing environment and accessed remotely (e.g., via a wireless network, such as the wireless network 132 shown in FIG. 1). As such, although the image analysis module 234 is shown within the computing system 220 in the example shown in FIG. 2, in other embodiments, at least portions of the image analysis module 234 may be stored in computing devices and/or networks outside of the computing system 220 that are communicatively coupled to the computing system 220.

Once the computing system 220 detects considerable difference between the posture estimation and the recommended posture, the computing system 220 outputs a first command responsive to a difference between the current posture and the recommended posture exceeding a threshold difference, wherein the first command is configured to cause one or more actuators 214 to provide force feedback to the occupant. Each actuator 214 of the one or more actuators 214 may be implemented in the same or in a different way than the other actuators 214 of the one or more actuators. Each actuator 214 may be any kind of actuator that is able to provide force feedback of any kind to the occupant. One or more actuators 214 may be arranged in or on a sitting surface of a vehicle seat the occupant is seated on. Additionally or alternatively, one or more actuators 214 may be arranged in or on a backrest and/or a headrest of the vehicle seat. Depending on where each of the one or more actuators 214 is arranged in or on the vehicle seat, force feedback may be provided to the legs of the occupant, the buttocks of the occupant, the back of the occupant, the shoulders of the occupant, the neck of the occupant, and/or the head of the occupant, for example.

Providing force feedback to the occupant may include generating vibrations perceptible by the occupant, and/or exerting pressure on one or more body parts of the occupant, for example. That is, according to some embodiments, at least one of the one or more actuators 214 may be configured to provide vibration-feedback to the occupant. Additionally, or alternatively, at least one of the one or more actuators may be configured to adjust settings of a lumbar support integrated in the seat of the vehicle, thereby providing pressure-feedback to the occupant. In this way, defined impulses can be provided to the occupant, which stimulate limb movement. In particular, when the occupant perceives force feedback from one or more of the one or more actuators 214, this may be perceived as an indication that the current posture of the occupant does not match the recommended posture. Further, any kind of force feedback perceived by an occupant generally triggers at least unconscious movement of one or more body parts. In this way, the occupant is encouraged to take on a somewhat different, e.g., more upright, body posture without startling the occupant, and with only little interaction required by the occupant. That is, the occupant, and especially the driver of a vehicle is not distracted. By providing force feedback and/or by redistributing pressure on certain body parts, the occupant is encouraged to take on an upright position, which is generally considered as desirable. In this way, comfort of the occupant is highly improved, and fatigue may be reduced.

A method for performing the data flow of FIG. 2 will now be described. Turning to FIG. 3, an example method 300 for determining a posture of a vehicle occupant and outputting a first command is shown. The method 300 may be executed by a processor of a computing system (e.g., the computing system 120 of FIG. 1 or the computing system 220 of FIG. 2) based on instructions stored on a memory of the computing system (e.g., the memory 144 of FIG. 1). The method 300 will be described with regard to the systems and components of FIGS. 1 and 2. However, it may be understood that the method may be implemented with other systems and components without departing from the scope of the present disclosure. For clarity, the method 300 will be described with respect to one occupant, which may be a driver or a passenger of the vehicle, although the method 300 may be used to determine the posture of more than one occupant at the same time.

In some examples, the method 300 may be executed in response to a new occupant being detected and/or in response to the occupant adjusting their seat. As another example, additionally or alternatively, the method 300 may be executed at a pre-determined frequency during vehicle operation, such as every 10 minutes, every 30 minutes, every 60 minutes, etc. In some examples, a user may select or adjust the pre-determined frequency. Further, in some examples, the method 300 may be temporarily disabled (e.g., automatically or by the occupant) and/or modified during poor visibility (e.g., fog, heavy rain, snow) or poor road conditions (e.g., slick, icy, or bumpy) while the vehicle is operating at a non-zero speed, as will be elaborated below.

At 302, the method 300 includes receiving images from a camera. As described above with respect to FIG. 1, the camera may include one or more optical, infrared, and depth cameras and may include one or more view angles for capturing images. Further, the camera may capture a sequence of images at a pre-programmed frequency, such as a frequency in a range from 8-24 frames per second. Alternatively, the pre-programmed frequency may be greater than 24 frames per second or less than 8 frames per second. The computing system may receive the images captured by the camera as they are acquired via wired or wireless communication methods, such as Ethernet, USB, Bluetooth®, and WiFi.

At 304, the method 300 includes analyzing the images received from the camera to determine occupant posture. As described above with respect to FIG. 2, the computing system may include an image analysis module (e.g., the image analysis module 234) that analyzes the images received from the camera in real-time to identify one or more features of the occupant in each of the received images. For example, the image analysis module may use one or any combination of an image library, a model, and an algorithm for recognizing the vehicle occupant as well as interior features of the vehicle, such as a seat the occupant is sitting in, a steering wheel, etc. As one example, the computing system may distinguish the driver from one or more additional vehicle occupants based on the location of the respective occupant relative to the steering wheel.

In some embodiments, the computing system may perform facial recognition (e.g., via a biometric algorithm) to determine an identity of the occupant. For example, the identity may include a name or user identification number that is associated with previously received/measured/estimated body measurements, recommended postures, seat settings, or other preferences. When the occupant is unknown, such as when the occupant has not been previously identified, the computing system may create a new user identification number and store images of the occupant for future facial recognition.

Analyzing the images received from the camera to determine occupant posture includes determining occupant body measurements, as indicated at 306. The body measurements may include, but are not limited to, an arm length, a foot length or shoe size, a thigh length, a height, a neck length, and a waist circumference, a weight, and a body mass index (BMI). In some examples, the occupant inputs at least one of the body measurements via a user interface (e.g., the user interface 116 of FIG. 1 or the user interface 216 of FIG. 2). The user interface may be integrated in the vehicle or may be included in a mobile device (e.g., a smartphone, tablet, or smartwatch) that is running a companion application and is in communication with the computing system. For example, the user interface may prompt the occupant to enter and/or update body measurements at a pre-determined frequency (e.g., once a month) or when a new occupant is detected. As another example, additionally or alternatively, the computing system may receive information regarding at least one of the occupant body measurements from an in-vehicle sensor, such as a weight sensor positioned in the seat (e.g., the driver seat sensor 124 of FIG. 1).

Additionally or alternatively, the computing system may estimate at least one of the body measurements based on the received images. For example, depth and/or visible light information acquired by the camera may be used to define a surface area and/or volume of the occupant, which in turn may be used to determine the various body measurements. Further, skeletal tracking may be used to identify joints (e.g., joint angles) and limb lengths. As described above with respect to FIG. 2 and as will be illustrated in FIGS. 4 and 5, the computing system may model a virtual skeleton of the occupant to determine joint angles and limb lengths.

Analyzing the images received from the camera to determine occupant posture may include determining a seat position, as indicated at 308. The seat position may include, for example, a seat height, a seat angle (e.g., of a seat back relative to a seat cushion), a seat tilt (e.g., of the seat cushion), and a longitudinal seat position. For example, the computing system may identify the seat, including the seat back, the seat cushion, and a headrest, via a computer vision or image recognition algorithm and geometrically analyze the seat back relative to the seat cushion, the seat relative to the dashboard, etc. to determine the seat position. Additionally or alternatively, the computing system may determine the seat position based on an output of a seat position sensor and/or based on feedback from (or a setting of) a seat motor.

When the occupant is the driver, analyzing the images received from the camera to determine occupant posture may include determining a steering wheel position, as optionally indicated at 310. The steering wheel position may include a steering wheel height and tilt angle, for example. The computing system may identify the steering wheel via a computer vision or image recognition algorithm and geometrically analyze the steering wheel relative to the dashboard, relative to a ceiling of the vehicle, relative to a floor of the vehicle, etc. to determine the steering wheel position. Additionally or alternatively, the computing system may determine the steering wheel position based on feedback from (or a setting of) an electronic motor within a steering column that is used to adjust the position of the steering wheel.

Analyzing the images received from the camera to determine occupant posture may include determining the occupant's body position relative to the seat, as indicated at 312. For example, the occupant's body position relative to the seat may include a distance between the occupant's head and the headrest, a distance between the occupant's shoulders relative to the seat back, a distance between the occupant's hips relative to the seat back and seat cushion, and a distance between the occupant's knees and the seat cushion. The distance for each of the above examples may be zero or non-zero. An example where the distance between the occupant's head and the headrest is zero will be described with respect to FIG. 4, while an example where the distance between the occupant's head and the headrest is non-zero will be described with respect to FIG. 5. Further, the computing device may estimate the various distances described above according to a real world measurement scale (e.g., inches), a pixel-based scale, or another measurement scale that enables the computing device to compare distances from image to image. For example, the computing system may use an edge detection algorithm to determine a first boundary of the driver's head and a second boundary of the headrest and then determine a number of pixels in a shortest path directly between the first boundary and the second boundary.

When the occupant is the driver, analyzing the images received from the camera to determine occupant posture may further include determining the occupant's body position relative to the steering wheel, as optionally indicated at 314. For example, the occupant's body position relative to the steering wheel may include a clearance distance between the steering wheel and the torso, a clearance between the steering wheel and the thigh, etc. As an example, the computing system may use an edge detection algorithm to determine a first boundary of the steering wheel and a second boundary of the driver's torso and then determine a distance (e.g., in a real-world measurement unit, a number of pixels, or another measurement scale) in a shortest path directly between the first boundary and the second boundary.

At 316, the method 300 includes determining a recommended posture based on the body measurements of the occupant. The computing system may use these body measurements to deduce the recommended sitting posture according to posture recommendations that are stored in memory. For example, the posture recommendations may apply a plurality of body component-specific rules for ergonomic and effective vehicle operation that may be adaptable to a wide variety of body measurements. The posture recommendations may include, but are not limited to, a threshold seat angle range, a threshold clearance distance between the steering wheel and the torso, a threshold clearance between the steering wheel and the thigh, a threshold distance between the head and the headrest, a threshold knee angle range, a threshold hip angle range, a threshold elbow angle range, etc. For example, the computing system may input the body measurements of the occupant into one or more look-up tables or algorithms, which may output the specific posture recommendations for the given body measurements. As one example, the threshold clearance distance between the steering wheel and the torso may be larger for individuals having longer limbs (e.g., longer arms and/or legs) than individuals having shorter limbs. As another example, the threshold distance between the head and the headrest may be the same regardless of body measurements. The look-up table(s) or algorithm(s) may further output a recommended seat position and a recommended steering wheel position that will produce the recommended posture according to the posture recommendations for the given body measurements. Further, in some examples, the posture recommendations may undergo machine learning so that the plurality of body component-specific rules may be updated or refined according to data gathered for the specific occupant or similarly sized occupants.

Further, in some examples, the occupant may input physical limitations that may affect their posture. As one example, the occupant may have a disability or degenerative condition that renders them unable to sit according to the standard body component-specific rules. As such, the computing system may adjust the plurality of body component-specific rules for the given occupant based on the input physical limitations. As an illustrative example, the occupant may have a permanent spinal curvature that may restrict their ability to sit with their shoulders and head back. As such, the occupant may activate accessibility settings and input information regarding a back range of motion.

In some examples, the computing system may further take into account driving conditions, including weather conditions, terrain conditions, a length of time of a current vehicle trip, etc. For example, the plurality of body component-specific rules may be adjusted or relaxed during poor driving conditions so that the occupant, particularly when the occupant is the driver, may have a greater range of movement within the recommended posture. For example, during poor visibility conditions, the driver may instinctively angle their body forward (e.g., toward the steering wheel). As another example, the plurality of body component-specific rules may be less relaxed during a long trip to prevent fatigue.

At 318, the method 300 includes determining a postural difference between the recommended posture and the determined occupant posture. For example, the computing system may compare the actual sitting posture determined from the images from the camera and the recommended posture determined from the body measurements by comparing each specific posture recommendation to the determined posture. That is, the actual seat position may be compared to the recommended seat position, an actual elbow angle of the occupant may be compared to the threshold elbow angle range, etc. In some examples, the computing system may differently weight each posture component (e.g., seat position, steering wheel position, elbow angle, hip angle, various clearance distances) according to its posture contribution. For example, because the seat position may influence some or all of the various clearance distances and joint angles, the seat position may be more heavily weighted in the comparison, and so smaller differences in the seat position (e.g., one or more of the seat angle, seat height, and longitudinal position) may have a larger impact in determining if the postural difference is significant, as will be described below. As such, the postural difference may include a weighted sum, at least in some examples.

At 320, the method 300 includes determining if the postural difference is significant. A level of significance in the postural difference may be inferred using statistical analysis, such as common thumb rules. In some examples, the computing system may consider the body mass index as an additional factor in the inferencing. For example, an overweight body mass index may adversely affect postural dynamics and hence, even minor postural differences may be considered significant for such persons.

The method includes determining if the postural difference is greater than or equal to a threshold postural difference, such as by summing or tabulating a magnitude difference or a percentage difference of all of the deviations between the occupant posture and the recommended posture and comparing the sum to the threshold postural difference. The threshold postural difference may be a non-zero magnitude difference or percentage difference that is stored in memory that corresponds to a significant postural difference, for example. As mentioned above, some posture components may be weighted more heavily in the determination.

If the postural difference significant (e.g., statistically significant) or is greater than or equal to the threshold difference, the method 300 proceeds to 322 and includes outputting a first command causing one or more actuators of one or more actuators to provide force feedback to the occupant. The method 300 may then end.

If the postural difference is not significant or is less than the threshold difference, the method 300 may return to 302, for example. Alternatively, if the postural difference is not significant or is less than the threshold difference, the method 300 may end. According to some examples, because the occupant posture is determined to be substantially the same as the recommended posture when the postural difference is not significant (less than threshold difference), the occupant may be encouraged to maintain their current posture. In some examples, the user interface may output a symbol or any kind of feedback and/or message, such as a green check mark next to a posture item on a display or a chime output via the speakers, to inform the occupant that they are sitting in the recommended posture and encourage them to maintain their current posture.

According to some examples, a posture score may be determined based on the difference between the current posture and the recommended posture, wherein the posture score is highest when the difference between the current posture and the recommended posture is zero, and gradually decreases as the difference increases. That is, for example, the posture score may be 100% when the difference between the current posture and the recommended posture is zero. The greater the difference between the current posture and the recommended posture, the lower the posture score. Responsive to a difference between the current posture and the recommended posture not exceeding the threshold difference, a second command may be output, wherein the second command is configured to cause a user interface to present feedback to the occupant. According to some examples, the feedback presented to the occupant comprises a suitable representation of the posture score. This may include any kind of visualization of the posture score.

In this way, positive feedback may be provided to the occupant, if their current body position matches or does not significantly differ from a recommended body position. In this way, the occupant is encouraged to maintain their current body position. According to some examples, gamification elements may be provided to the occupant, such as, e.g., progress tracking. It is also possible that occupants receive rewards when maintaining a body position that is considered a good body position. Alternatively or additionally, periodic progress reports may be provided to the occupant. It is even possible that results of the posture difference determination be integrated with one or more smart devices of the occupant for further motivation. According to even further examples, results of the posture difference determination may be provided to insurance companies. Premiums of an insurance may be determined based on the results of the posture difference determination, for example. That is, for example, insurance rates may be lowered if an insured person generally maintains a good body posture.

As one example, the ADAS module 236 may interface with the user interface 216 to provide output via a display 238. The display 238 may be integrated in the vehicle or may be a display of a smartphone running a companion app. For example, the display 238 may output messages and/or symbols.

Exemplary parameters or components that may be used by a computing system (e.g., the computing system 120 of FIG. 1 or the computing system 220 of FIG. 2) in determining a driver posture will now be described with reference to FIGS. 4 and 5. Features of FIGS. 4 and 5 that are the same throughout the different driver postures are numbered the same and will not be reintroduced between figures, while parameters (e.g., angles and distances) that change between the different driver postures are numbered differently, as will be elaborated below. For example, each of FIGS. 4 and 5 illustrates a side view of a driver 402 sitting in a driver seat 404, which may be the driver seat 104 of FIG. 1, for example. The driver seat 404 includes a headrest 404a, a seat back 404b, and a seat cushion 404c. The seat back 404b has a length 406, and the seat cushion 404c has a length 410. Further, the driver seat 404 is coupled to a floor of the vehicle (not shown) via a seat base 440. The seat base 440 is fixedly coupled (e.g., bolted) to the floor of the vehicle and does not move with respect to the floor of the vehicle. However, the driver seat 404 may move relative to the seat base. For example, a vertical position (e.g., seat height) and a longitudinal position (e.g., how forward or back the seat is with respect to the front and back of the vehicle) of the driver seat 404 may be adjusted with respect to the seat base 440. Each of FIGS. 4 and 5 further includes a steering wheel 412, which may be the steering wheel 112 of FIG. 1, for example, and a pedal 444, which may represent an accelerator pedal, a brake pedal, or a clutch.

A virtual skeleton 408 may be mapped onto (e.g., overlaid on) the driver 402 and may include nodes representing joints and dashed lines representing the general connectivity of the joints. In the example shown, the virtual skeleton 408 maps ankle, knee, hip, wrist, elbow, shoulder, and neck joints. The virtual skeleton 408 may be used by the computing system to aid in determining the driver posture, such as described above with respect to FIGS. 2 and 3. For example, the virtual skeleton 408, and thus the driver 402, has a torso length 418 extending between the neck joint and a midpoint between hip joints (e.g., at a pelvis), an upper leg (e.g., thigh) length 420 extending between the hip joint and the knee joint, a lower leg (e.g., shin) length 424 extending between the ankle joint and the knee joint, an upper arm length 428 extending between the shoulder joint and the elbow joint, and a lower arm length 430 extending between the elbow joint and the wrist joint. Although not shown in FIGS. 4 and 5, other body measurements may also be estimated, such as an angle of a head 416 of the driver 402, a foot length and angle, etc. As such, FIGS. 4 and 5 are meant to illustrate non-limiting examples of different body measurements that may be obtained according to the systems and methods described herein and illustrate one exemplary embodiment of postural mapping using a virtual skeleton.

Referring now to FIG. 4, a first posture 400 is shown. The first posture 400 is one example of a recommended driving posture that follows posture recommendations for ergonomic and effective vehicle operation, such as described with respect to FIG. 3. In the first posture 400, the driver seat 404 is positioned at a seat angle 414, and the head 416 is in contact with the headrest 404a such that there is no distance (e.g., space) between the head 416 and the headrest 404a. For example, the seat angle 414 may be within a threshold range for driver comfort and vision. The threshold range may help ensure that the driver 402 is not so reclined that vehicle operation is obstructed and not so inclined that comfort is reduced.

The first posture 400 further includes a first clearance distance 434 between the steering wheel 412 and the torso of the driver 402, a second clearance distance 436 between the steering wheel 412 and the thigh of the driver 402, and a longitudinal seat position represented by a distance 442 between a forward-most upper corner of the seat base 440 (with respect to the vehicle) and a forward-most edge of the seat cushion 404c. However, the computing system may use other references in determining the longitudinal seat position. Although not shown in the present example, a seat height may also be determined.

The first posture 400 further includes a knee angle 426, a hip angle 422, and an elbow angle 432. The knee angle 426 is formed at the knee joint between the lower leg length 424 and the upper leg length 420, the hip angle is formed at the hip joint between the upper leg length 420 and the torso length 418, and the elbow angle 432 is formed at the elbow joint between the lower arm length 430 and the upper arm length 428. Note that although FIG. 4 is a two-dimensional illustration of a 3D scene, the knee angle 426, the hip angle 422, and the elbow angle 432 may be defined in three dimensions (e.g., using x, y, and z world coordinates).

Due to the longitudinal seat position represented by the distance 442 and the seat angle 414, the first clearance distance 434 and the second clearance distance 436 provide sufficient room for the driver to maneuver without contacting the steering wheel 412. Further, the knee angle 426 allows the driver to fully depress the pedal 444 without fully unbending the knee joint. Further, because the driver's arms are bent at the obtuse elbow angle 432, the driver may easily reach the steering wheel 412.

Referring now to FIG. 5, a second posture 500 is shown. The second posture 500 is an example of an incorrect driving posture that may cause driver strain and/or degrade the driver's ability to operate the vehicle. In the second posture 500, the driver seat 404 is positioned at a seat angle 514 and has a longitudinal position with a distance 542 between the forward-most upper corner of the seat base 440 and a forward-most edge of the seat cushion 404 c. The seat angle 514 is less than the seat angle 414 of the first posture 400 of FIG. 4 and is outside of the threshold range for driver comfort and vision. For example, the seat angle 514 may be approximately 90 degrees, causing the seat back 404b to be so vertically upright that the driver 402 hunches forward toward the steering wheel 412. As a result, a hip angle 522 of the driver 402 in the second posture 500 is also less than the hip angle 422 of the first posture 400 of FIG. 4. The distance 542 of the second posture 500 is greater than the distance 442 of the first posture 400. Thus, the longitudinal position of the seat 404 is further forward in the second posture 500 than in the first posture 400 of FIG. 4. As a result of both the further forward longitudinal position and the smaller seat angle 514, both a first clearance distance 534 between the steering wheel 412 and the torso of the driver 402 and the second clearance distance 536 between the steering wheel 412 and the knee of the driver 402 are less than the first clearance distance 434 and the second clearance distance 436 of FIG. 4, respectively. As a result of the smaller second clearance distance 536, the driver 402 may be more likely to contact the steering wheel 412 with a knee. Further, the head 416 is a distance 538 from the headrest 404a. As a result, the driver 402 may expend additional energy and experience muscle fatigue by leaning forward instead of resting the head 416 against the headrest 404a and may be closer to the steering wheel 412 than desired for vehicle operation.

The second posture 500 further includes a knee angle 526 and an elbow angle 532. Because the first clearance distance 534 in the second posture 500 is smaller than the first clearance distance 434 in the first posture 400, the elbow angle 532 is smaller (e.g., more acute) than the elbow angle 432 of the first posture 400 of FIG. 4. Similarly, the knee angle 526 is smaller (e.g., more acute) than the knee angle 426 of the first posture 400 of FIG. 4. Overall, the driver 402 is positioned inefficiently and in a manner that may cause strain and/or fatigue, making the second posture 500 undesirable. The computing system may provide feedback accordingly so that the occupant may adjust from the second posture 500 to another posture, e.g., the first posture 400, such as according to the method of FIG. 3.

Turning now to FIG. 6, a system for a vehicle 100 is schematically illustrated. The system comprises a camera 218, and a computing system 220 including instructions stored in non-transitory memory that, when executed, cause the computing system 220 to receive images captured of an occupant in the vehicle from the camera 218, determine body measurements of the occupant from the received images, determine a current posture of the occupant from the received images, determine a recommended posture for the occupant based on the determined body measurements, and output a first command responsive to a difference between the current posture and the recommended posture exceeding a threshold difference (bad posture), wherein the first command is configured to cause one or more actuators to provide force feedback 250 to the occupant.

The present application addresses various technical problems related to vehicle occupant posture monitoring and correction in real-time and during vehicle motion and/or stopped conditions, particularly the difficulty in accurate identifying proper ergonomic posture while focusing on vehicle operation to effect a positive change in the posture when proper posture is identified as lacking. Even optimal seat positions may not prevent occupants from adopting poor postures during extended vehicle trips. As noted herein, a camera-based vehicle occupant posture monitoring system is provided that automatically determines and generates output to correct occupant posture in real-time. The system comprises a camera positioned within the vehicle and a computing system with specialized image analysis capabilities. The computing system receives images of the vehicle occupant from the camera and employs computer vision techniques, including skeletal tracking with virtual skeleton mapping, to determine the occupant's body measurements and current posture. Using these measurements, the system calculates a recommended posture based on ergonomic principles and body component-specific posture recommendations stored in memory, and further may take into account driving conditions.

Technical benefits of this invention include automated posture correction with less conscious effort from the occupant, thereby maintaining focus on vehicle operation while improving comfort and reducing fatigue. When the system detects a significant difference between the current posture and the recommended posture (exceeding a predetermined threshold), it outputs commands to actuators positioned within the vehicle seat that provide force feedback to the occupant. This force feedback can include vibrations or pressure adjustments through lumbar support mechanisms, which naturally encourage the occupant to adjust their posture. Further, these prompts can be provided during selected driving conditions such as when the steering wheel is centered (non-turning) and/or with vehicle speed within selected thresholds. The system also provides positive reinforcement through a user interface when good posture is maintained, including posture scoring and gamification elements. Additionally, the system can integrate with external sensors and smart devices to predict when poor posture is most likely to occur, enabling proactive intervention and enhanced effectiveness in maintaining optimal occupant comfort throughout the entire vehicle journey.

In an example, posture detection may utilize enhanced skeletal tracking with dimensional analysis. For example, the image analysis module 234 may employ skeletal tracking algorithms that map specific anatomical landmarks to determine precise body measurements and postural deviations. For example, the system may identify reference points including the C7 vertebra (base of neck), acromion process (shoulder point), greater trochanter (hip joint), lateral epicondyle of the knee, and lateral malleolus (ankle). Using these landmarks, the system may calculate limb segment ratios and joint angles in three-dimensional space.

The computing system 220 may then determine recommended posture parameters based on anthropometric relationships. For example, for occupants with torso lengths below a lower threshold (shorter drivers), the system may calculate that optimal hip angles should fall within a first predetermined range, while for occupants with torso lengths exceeding an upper threshold (taller drivers), the optimal hip angles should fall within a second predetermined range that accommodates their longer torso segments, different from the first range. Similarly, the recommended clearance distance between the steering wheel and torso varies proportionally based on measured body dimensions, with shorter drivers utilizing clearance distances within a first range and taller drivers requiring clearance distances within a second, larger range.

When the camera 218 detects that a shorter driver exhibits postural deviations including hip angles below the recommended range, excessive forward head positioning, elbow angles below optimal thresholds, and/or insufficient clearance distances, the computing system 220 outputs targeted commands to actuators 214. For shorter drivers with forward hunching posture, the lumbar support actuator increases pressure in the lower back region to encourage posterior pelvic tilt and increase hip angle measurements. Upper back vibration actuators provide gentle pulsing vibrations at predetermined first frequencies and intervals at mid-thoracic vertebrae levels to encourage the driver to lean back against the seat back 404b. The seat position motor 134 automatically adjusts the longitudinal seat position rearward by a calculated distance to increase clearance distance, while the headrest actuator moves the headrest 404a forward to reduce excessive distance between the head and headrest.

For taller drivers exhibiting different postural challenges such as shoulder protraction, excessive forward head posture, hip angles above the recommended upper threshold, and knee angles below optimal ranges, the system provides alternative corrective actions. Upper thoracic vibration actuators provide targeted vibrations at higher second frequencies and longer intervals at upper vertebrae levels to encourage shoulder retraction. Bilateral shoulder blade actuators apply gentle pressure pulses at the medial borders of both scapulae to promote proper shoulder positioning. The seat height motor lowers the seat position to achieve proper knee angles within the recommended range for taller occupants, while the seat back angle adjustment increases recline to accommodate longer torso lengths and reduce excessive hip flexion. The steering column motor adjusts steering wheel height upward and extends the telescoping function to maintain proper clearance distances appropriate for taller drivers.

The system may also integrate with external sensors 124, 126 to monitor physiological indicators and detect early signs of postural fatigue. When heart rate variability decreases below a predetermined threshold from baseline measurements, the system implements dimension-specific preemptive adjustments. For shorter drivers, the system increases lumbar support by a predetermined percentage and initiates reminder vibrations at calculated intervals. For taller drivers, the system adjusts the seat back angle by additional degrees of recline and provides upper back massage patterns through the actuators 214.

During extended driving sessions exceeding predetermined time thresholds, the system implements progressive postural adjustments tailored to occupant dimensions. Shorter drivers receive gradually increasing lumbar support in predetermined increments at regular intervals and periodic shoulder blade vibrations. Taller drivers receive alternating upper and lower back pressure point stimulation to prevent muscle stiffness in their longer torso segments. These time-based adjustments account for the different fatigue patterns and postural challenges associated with varying body dimensions.

The computing system 220 may employ multiple threshold comparisons to determine when corrective action is necessary. When measured joint angles fall outside predetermined ranges specific to the occupant's body measurements, when clearance distances are below minimum thresholds or above maximum thresholds for the occupant's dimensions, and/or when postural scores fall below acceptable levels, the system triggers appropriate actuator responses. The threshold values are dynamically adjusted based on the occupant's specific anthropometric measurements, ensuring that corrective feedback is appropriately scaled to individual body dimensions and postural requirements.

This dimensional approach enables the system to provide personalized ergonomic support that addresses the unique postural challenges faced by occupants with different body measurements, delivering targeted corrective actions that are specifically tailored to individual anthropometric characteristics and postural deviations.

Note that the computing system 220 implements real-time control algorithms that continuously monitor driving conditions and occupant posture to provide timely physical adjustments through the actuators 214 while maintaining vehicle driveability. The system may integrate with vehicle sensors including accelerometers, gyroscopes, steering angle sensors, and speed sensors to determine when actuator interventions are appropriate based on current driving dynamics. When the vehicle is traveling in a straight line at steady speeds below a predetermined threshold but above a lower threshold, the system actively provides corrective feedback through the actuators 214. However, during dynamic driving maneuvers such as cornering, lane changes, or braking events with braking effort above an upper threshold, the computing system 220 temporarily suspends actuator operations to reduce driver distraction or over-reaction during selected vehicle control moments.

Further examples of real-time actuator control employing different intervention strategies based on occupant dimensions and current driving conditions are provided. For shorter drivers exhibiting forward hunching posture during highway driving, the system gradually increases lumbar support pressure through pneumatic or electric actuators positioned at the L3-L5 vertebrae region while simultaneously providing gentle vibratory pulses at the upper thoracic region to encourage backward movement against the seat back 404b. These adjustments occur progressively over predetermined time intervals, with the lumbar support increasing in incremental steps every few seconds until the desired hip angle is achieved or the driver naturally adjusts their position in response to the feedback.

For taller drivers who tend to slouch during extended driving periods, the system implements a different real-time correction protocol. Upper back actuators provide targeted pressure point stimulation at the T1-T4 vertebrae level through inflatable bladders or mechanical pressure pads that extend and retract in coordinated patterns. The system simultaneously adjusts the seat back angle through motorized mechanisms, gradually increasing recline by small increments while monitoring the driver's response through the camera 218. If the camera detects that the taller driver is maintaining improved shoulder positioning, the system maintains the current actuator settings and provides positive reinforcement through the user interface 216.

The computing system 220 continuously analyzes vehicle telemetry data to determine appropriate timing for actuator interventions. When the vehicle's lateral acceleration exceeds a predetermined threshold indicating cornering maneuvers, or when steering wheel angle changes exceed specified rates indicating lane changes or evasive actions, the system ceases all actuator proactive adjustments and enters a monitoring-only mode. Similarly, during high-speed driving conditions above predetermined velocity thresholds, or when rapid deceleration events are detected through brake pedal sensors or vehicle deceleration measurements, the actuator system remains inactive to reduce interference with the driver's vehicle control inputs.

The system employs predictive algorithms that analyze driving patterns to anticipate when actuator interventions may be most effective. During steady-state highway cruising, the system increases the frequency of posture monitoring and provides more aggressive corrective feedback through the actuators 214. In urban driving environments with frequent stops and turns, the system reduces actuator intervention intensity and focuses on maintaining baseline lumbar support settings while avoiding distracting vibrations or pressure changes during critical driving moments.

The actuator control system implements graduated response protocols that escalate intervention intensity based on the severity and duration of postural deviations. Initial interventions begin with subtle pressure adjustments through lumbar support mechanisms on a slower time-scale, followed by gentle vibratory feedback if postural improvements are not detected within predetermined time windows. For persistent postural deviations, the system progresses to more noticeable interventions including coordinated seat position adjustments through the seat motors 134, 138, combined with synchronized actuator feedback patterns at a higher time-scale.

According to some embodiments, the instructions stored in non-transitory memory, when executed, further cause the computing system 220 to determine a posture score based on the difference between the current posture and the recommended posture, wherein the posture score is highest when the difference between the current posture and the recommended posture is zero, and gradually decreases as the difference increases. According to even further embodiments, the instructions stored in non-transitory memory, when executed, further cause the computing system 220 to output a second command responsive to a difference between the current posture and the recommended posture not exceeding the threshold difference (good posture), wherein the second command is configured to cause a user interface 252 to present feedback to the occupant. The feedback presented to the occupant may comprise a suitable representation of the posture score, for example.

According to further embodiments of the disclosure, the occupant may be positioned in a seat of the vehicle 100, wherein to determine the current posture of the occupant from the received images, the computing system 220 includes further instructions stored in the non-transitory memory that, when executed, cause the computing system 220 to determine a plurality of posture components of the occupant from the received images, the plurality of posture components including an angle of each joint of the occupant, a position of the occupant relative to the seat of the vehicle, and seat position settings of the seat. Additionally, to determine the recommended posture for the occupant based on the determined body measurements, the computing system 220 may include further instructions stored in the non-transitory memory that, when executed, cause the computing system 220 to determine a plurality of recommended posture components for the occupant based on the body measurements and a plurality of body component-specific posture recommendations, the plurality of recommended posture components including a recommended angle of each joint, a recommended position of the occupant relative to the seat, and recommended seat position settings.

According to some embodiments, the occupant may be positioned in a seat of the vehicle 100, the one or more actuators may be arranged in or on the seat of the vehicle 100, and the first command may include instructions for at least one of the one or more actuators to provide vibration-feedback to the occupant. Alternatively or additionally, the first command may include instructions for at least one of the one or more actuators to adjust settings of a lumbar support integrated in the seat of the vehicle 100.

According to some embodiments, the system may be in communication with at least one sensor external to the system, and the instructions stored in non-transitory memory, when executed, further cause the computing system 220 to receive data captured by the at least one sensor external to the system, and, based on the data received from the at least one sensor external to the system, make predictions concerning defined times at which a difference between the current posture and the recommended posture is most likely to exceed the threshold difference. The system may be in communication with at least one sensor arranged in or connected to a smart device worn by the occupant, for example.

That is, the system may aggregate data from sensors other than the sensors arranged in the vehicle. In this way, the system may be able to make predictions at what times an occupant will be most likely to take on a bad body position. For example, an occupant may always take on a bad body position in the vehicle when returning from a sports session. If the system receives data from external sensors and devices such as, e.g., smart watches or other smart devices worn by the occupant, the system knows when the occupant returns from a sports session (e.g., increased heart rate may have been detected over a defined period of time). In such cases (e.g., in response to a defined triggering event), measures may be taken by the system immediately at the beginning of a driving session, even if no body position measurements have been performed yet. Alternatively, or additionally, body positions measurements may be performed more often during a defined time interval (e.g., during a driving session immediately after it has been detected that the occupant performed a sport session). This makes the system even more effective and more positive reinforcement may be provided to the occupant.

According to even further embodiments, the instructions stored in non-transitory memory, when executed, may further cause the computing system 220 to store information concerning the difference between the current posture and the recommended posture in memory for later evaluation.

Turning now to FIG. 7, an example method 700 is schematically illustrated. The method 700 may be executed by a processor of a computing system (e.g., the computing system 120 of FIG. 1 or the computing system 220 of FIG. 2) based on instructions stored on a memory of the computing system (e.g., the memory 144 of FIG. 1). The method 700 will be described with regard to the systems and components of FIGS. 1 and 2. However, it may be understood that the method may be implemented with other systems and components without departing from the scope of the present disclosure. For clarity, the method 700 will be described with respect to one vehicle seat, which may be a driver seat or a passenger seat of the vehicle, although the method 700 may be used to adjust more than one seat at the same time. The method, at 702, comprises receiving images captured of an occupant in the vehicle from the camera 218. At 704, the method includes performing body measurements of the occupant from the received images, and determining a current posture of the occupant from the received images. At 706, the method includes comparing the determined occupant posture to a recommended posture for the occupant. At 708 a difference between the occupant posture and the recommended posture is determined. If a significant postural difference is determined, the method may proceed to 710 and output a first command, wherein the first command is configured to cause one or more actuators to provide force feedback to the occupant. The method may then end. If no significant postural difference is determined, the method may proceed to 712 and provide respective feedback to the occupant. For example, a representation of a determined posture score may be presented to the occupant to provide positive feedback and motivate the occupant to keep up the good posture. The method may then end.

The technical effect of monitoring a sitting posture of a vehicle occupant and providing feedback in response to the sitting posture being significantly different from a recommended posture is that a comfort of the vehicle occupant may be increased.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for a vehicle, the system comprising:
a camera; and
a computing system including instructions stored in non-transitory memory that, when executed, cause the computing system to:
receive images captured of an occupant in the vehicle from the camera;
determine body measurements of the occupant from the received images;
determine a current posture of the occupant from the received images;
determine a recommended posture for the occupant based on the determined body measurements; and
output a first command responsive to a difference between the current posture and the recommended posture exceeding a threshold difference, wherein the first command is configured to cause one or more actuators to provide force feedback to the occupant.

2. The system of claim 1, wherein the instructions stored in non-transitory memory, when executed, further cause the computing system to:
determine a posture score based on the difference between the current posture and the recommended posture, wherein the posture score is highest when the difference between the current posture and the recommended posture is zero, and gradually decreases as the difference increases.

3. The system of claim 2, wherein the instructions stored in non-transitory memory, when executed, further cause the computing system to:
output a second command responsive to a difference between the current posture and the recommended posture not exceeding the threshold difference, wherein the second command is configured to cause a user interface to present feedback to the occupant.

4. The system of claim 3, wherein the feedback presented to the occupant comprises a representation of the posture score.

5. The system of claim 1, wherein the occupant is positioned in a seat of the vehicle, and wherein to determine the current posture of the occupant from the received images, the computing system includes further instructions stored in the non-transitory memory that, when executed, cause the computing system to:
determine a plurality of posture components of the occupant from the received images, the plurality of posture components including an angle of each joint of the occupant, a position of the occupant relative to the seat of the vehicle, and seat position settings of the seat.

6. The system of claim 5, wherein to determine the recommended posture for the occupant based on the determined body measurements, the computing system includes further instructions stored in the non-transitory memory that, when executed, cause the computing system to:
determine a plurality of recommended posture components for the occupant based on the body measurements and a plurality of body component-specific posture recommendations, the plurality of recommended posture components including a recommended angle of each joint, a recommended position of the occupant relative to the seat, and recommended seat position settings.

7. The system of claim 1, wherein the occupant is positioned in a seat of the vehicle, the one or more actuators are arranged in or on the seat of the vehicle, and wherein the first command includes instructions for at least one of the one or more actuators to provide vibration-feedback to the occupant.

8. The system of claim 1, wherein the occupant is positioned in a seat of the vehicle, the one or more actuators are arranged in or on the seat of the vehicle, and wherein the first command includes instructions for at least one of the one or more actuators to adjust settings of a lumbar support integrated in the seat of the vehicle.

9. The system of claim 1, wherein the system is in communication with at least one sensor external to the system, and the instructions stored in non-transitory memory, when executed, further cause the computing system to:
receive data captured by the at least one sensor external to the system; and
based on the data received from the at least one sensor external to the system, make predictions concerning defined times at which a difference between the current posture and the recommended posture is most likely to exceed the threshold difference.

10. The system of claim 9, wherein the system is in communication with at least one sensor arranged in or connected to a smart device worn by the occupant.

11. The system of claim 1, wherein the instructions stored in non-transitory memory, when executed, further cause the computing system to:
store information concerning the difference between the current posture and the recommended posture in memory for later evaluation.

12. A system for a vehicle, the system comprising:
a camera for monitoring an occupant in real-time during vehicle operation; and
a computing system including instructions stored in non-transitory memory that, when executed, cause the computing system to:
receive images captured of the occupant in the vehicle from the camera;
determine body measurements of the occupant from the received images;
determine a posture deviations of the occupant from the received images as compared to desired posture; and
generate output to adjust one or more vehicle actuators responsive to the determined posture deviations and further based on vehicle driving conditions.

13. The system of claim 12, wherein generating the output includes providing different output for tall drivers as compared to short drivers to correct driver posture.

14. The system of claim 12, wherein generating the output includes providing different timing of output for tall drivers as compared to short drivers to correct driver posture.

15. The system of claim 12, wherein the computing system further includes instructions stored in non-transitory memory that, when executed, cause the computing system to suppress the generated output during selected vehicle driving conditions.
